(19) United States
(12) Patent Application Publication
(10) Pub. No.: US 2025/0211288 A1
(43) Pub. Date: Jun. 26, 2025

(54) METHOD FOR OPTIMIZING A RECONFIGURABLE INTELLIGENT SURFACE

(71) Applicant: Commissariat à l’énergie atomique et aux énergies alternatives, Paris (FR)

(72) Inventors: Frédéric MUNOZ, Grenoble Cedex 9 (FR); Raffaele D’ERRICO, Grenoble Cedex 9 (FR)

(73) Assignee: Commissariat à l’énergie atomique et aux énergies alternatives, Paris (FR)

(21) Appl. No.: 18/987,157

(22) Filed: Dec. 19, 2024

(30) Foreign Application Priority Data
Dec. 20, 2023 (FR) FR2314603

(51) Int. Cl. H04B 7/04; H04L 25/02

(52) U.S. Cl. CPC H04B 7/04013; H04L 25/0204

(57) ABSTRACT

The present invention relates to a method for optimizing a reconfigurable intelligent surface, comprising the following successive steps:
for a current configuration of said reconfigurable intelligent surface, the acquisition (62) of at least one measurement of the multi-path propagation channel associated with the communication and/or location system comprising at least said reconfigurable intelligent surface, at least one transmitter and at least one receiver;
on the basis of said acquisition, estimation of said multi-path channel;
within said multi-path channel estimation, isolation of the component of said reconfigurable intelligent surface;
computation of a cost function using said isolated component;
said successive steps being reiterated after modification, at each iteration, of said current configuration, until a predetermined stopping criterion is reached, the optimal configuration being associated with the iteration the cost value of which is maximum.

### CROSS-REFERENCE TO RELATED APPLICATIONS

This application is a U.S. non-provisional application claiming the benefit of French Application No. 23 14603, filed on Dec. 20, 2023, which is incorporated herein by reference in its entirety.

### FIELD

The present invention relates to a method for optimizing a reconfigurable intelligent surface, said surface comprising a plurality of elements, each controllable in phase and/or amplitude, said reconfigurable intelligent surface being suitable for reflecting or transmitting signals between at least one transmitter and at least one receiver.

The present invention further relates to a computer program including software instructions which, when executed by a computer, implement such a method for optimizing a reconfigurable intelligent surface.

The present invention also relates to a communication and/or location system comprising at least: at least one reconfigurable intelligent surface, said surface comprising a plurality of elements, each controllable in phase and/or amplitude, said reconfigurable intelligent surface being suitable for reflecting or transmitting signals between at least one transmitter and at least one receiver, said at least one transmitter, said at least one receiver.

### BACKGROUND

The present invention is therefore part of the field of Reconfigurable Intelligent Surfaces (RIS), in particular for wireless telecommunications applications, detection and localization, minimization of exposure to electromagnetic waves, or for modifications of the electromagnetic environment.

In the context of telecommunications links at millimeter wavelengths or “sub-terahertz” sub-THz, the blocking of the direct communication link (i.e. direct link) due to obstacles is strongly present. Reconfigurable intelligent surfaces are a technical solution to extend the links by redirecting electromagnetic waves and thereby making it possible to bypass fixed obstacles.

More specifically, in the context of 5G/6G networks (i.e. fifth and sixth generation, respectively), the use of reconfigurable intelligent surfaces makes it possible to extend network coverage, and/or improve the accuracy of geolocation, and/or minimize exposure to electromagnetic waves.

More particularly, in the scenarios planned for 6G, reconfigurable intelligent surfaces are an integral part of the technologies that will improve services and solutions already existing in 5G while being destined to enable the emergence of new solutions.

To do this, optimizing each reconfigurable intelligent surface is a crucial step.

Currently, for favorable cases, such an optimization is possible and implemented by means of a gradient descent or by using unit cell modeling and cell by cell optimization with models of variable complexity, passing e.g. by canonical radiation diagrams, a radar equivalent surface model or else an impedance model.

Experimentally, the current propagation channel measurement in the presence of a reconfigurable intelligent surface is reduced to the simplified case of measurement in an anechoic chamber and/or with directional antennas and/or with short distances between antennas and the reconfigurable intelligent surface that do not correspond to the implementation actually envisaged.

Moreover, in experimental cases, often ideal, and different from the actually envisaged use of a reconfigurable intelligent surface, it is possible to do without optimization or to subject same to a manual (i.e. a “codebook”) listing the different possible states of the reconfigurable intelligent surface which has been built from simulations and/or models, or else to base same on a metric corresponding to a figure of merit obtained with the transfer function of the channel, including the contribution of the reconfigurable intelligent surface, often acquired on a few frequency points, the metric being strongly perturbed in the presence of a propagation channel which has many paths (i.e. phenomenon which occurs when a signal propagates through a plurality of ways (i.e. paths).

However, apart from such favorable cases, such optimization may prove difficult in unfavorable cases corresponding to complex scenarios, such as scenarios associated with a high diversity of multi-paths, or presenting a path, passing through the reconfigurable intelligent surface, negligible with regard to the context.

FIG. 1 illustrates a comparison of a favorable case A and an unfavorable case B and the associated, optimized and non-optimized frequency responses, of the CFR (Channel Frequency Response) channel.

More precisely, the favorable case A corresponds to the scenario involving a reconfigurable intelligent surface 10, a transmission antenna corresponding to a horn 12 pointed at the reconfigurable intelligent surface 10, a reception antenna also corresponding to a horn 14 pointed at the reconfigurable intelligent surface 10.

The unfavorable case B corresponds to the scenario also involving the reconfigurable intelligent surface 10, and the transmission antenna corresponding to a horn 12 pointed at the reconfigurable intelligent surface 10, but a reception antenna approaching a directional omni receiver 16 such as a monopole.

View 18 illustrates the frequency responses associated with optimized 20 and non-optimized 22 favorable case A, of the CFR channel, whereas view 24 illustrates the frequency responses associated optimized 26 and non-optimized 28 with unfavorable case B, of the CFR channel.

More precisely, at a frequency f, all the l∈ [symbol] 1 [symbol] paths coming from directions (ϕₗ, θₗ) with complex amplitudes αₗ and delays τₗ as well as the effect of the transfer function of H_{RX} of the antenna in reception gives the following expression for the frequency responses of the CFR channel where l_{RIS} is the index of the path coming from the reconfigurable intelligent surface:

$$CFR ( f ) = {H}_{RX} ( {ϕ}_{{l}_{RIS}} , {θ}_{{l}_{RIS}} ) {α}_{{l}_{RIS}} {e}^{- j 2 π f {τ}_{{l}_{RIS}}} + {\sum }_{l ∈ 〚 1 : L 〛 \backslash \{ {l}_{RIS} \}} {H}_{RX} ( {ϕ}_{l} , {θ}_{l} ) {α}_{l} {e}^{- j 2 π f {τ}_{l}}$$

Thus, in the “unfavorable” scenario B where the receiver antenna approaches a directional omni receiver 16, i.e. H_{RX}(ϕ, θ)=1, the first term that corresponds to the contribution of the reconfigurable intelligent surface becomes negligible when:

$${\vert {H}_{RX} ( {ϕ}_{{l}_{RIS}} , {θ}_{{l}_{RIS}} ) {α}_{{l}_{RIS}} \vert}^{2} << {\vert {\sum }_{l ∈ 〚 1 : L 〛 \backslash \{ {l}_{RIS} \}} {H}_{RX} ( {ϕ}_{l} , {θ}_{l} ) {α}_{l} \vert}^{2}$$

giving then

$$CFR ( f ) \approx {\sum }_{l ∈ 〚 1 : L 〛 \backslash \{ {l}_{RIS} \}} {H}_{R X} ( {ϕ}_{l} , {θ}_{l} ) {α}_{l} {e}^{- j 2 π f {τ}_{l}} .$$

The modification and optimization of the reconfigurable intelligent surface becomes impossible because same changes only the parameter αₗ_{_{RIS}} (at first order) that is part of the neglected term.

On the other hand, in the “favorable” scenario A where the antenna in reception is a horn 14 pointed at the reconfigurable intelligent surface, we obtain approximately:

$${\vert {H}_{RX} ( {ϕ}_{{l}_{RIS}} , {θ}_{{l}_{RIS}} ) \vert}^{2} >> {\vert {\sum }_{l ∈ 〚 1 : L 〛 \backslash \{ {l}_{RIS} \}} {H}_{RX} ( {ϕ}_{l} , {θ}_{l} ) \vert}^{2}$$

giving the opposite situation where

$$CFR ( f ) \approx {H}_{R X} ( {ϕ}_{{l}_{RIS}} , {θ}_{{l}_{RIS}} ) {α}_{{l}_{RIS}} {e}^{- j 2 π f {τ}_{{l}_{RIS}}} ,$$

so that in such favorable case, the frequency response becomes relevant for quantifying the contribution of the reconfigurable intelligent surface and for optimizing same.

In other words, the current optimizations of a reconfigurable intelligent surface suitable for favorable cases do not allow the minimizing of the effect of multiple paths (i.e. the multi-path effect) not influenced by the reconfigurable intelligent surface considered, nor to extract the effect thereof from any context.

### SUMMARY

The goal of the invention is then to improve the optimization of a reconfigurable intelligent surface irrespective of the multi-path and antennas present during the measurement, so as to cover unfavorable scenarios where the contribution of the reconfigurable intelligent surface to the propagation channel is not predominant.

In other words, the present invention aims at proposing a solution to optimize a reconfigurable intelligent surface by minimizing, during the optimization, the effect of the multi-path (i.e. multiple paths) not influenced by the reconfigurable intelligent surface, and to extract the effect of the reconfigurable intelligent surface from any context.

To this end, the subject matter of the invention is a method for optimizing a reconfigurable intelligent surface, said surface comprising a plurality of elements, each controllable in phase and/or amplitude, said reconfigurable intelligent surface being suitable for reflecting or transmitting signals between at least one transmitter and at least one receiver, said method being implemented by an electronic device and comprising the following successive steps:
acquisition of at least one measurement of the propagation multi-path channel associated with the communication and/or location system, said system comprising at least said reconfigurable intelligent surface, said at least one transmitter and said at least one receiver, said acquisition being implemented for a current configuration of said reconfigurable intelligent surface;
on the basis of said acquisition, estimation of said multi-path channel;
within said multi-path channel estimation, isolation of the component of said reconfigurable intelligent surface;
computation of a cost function using said isolated component of said reconfigurable intelligent surface;
said successive steps being reiterated after modification, at each iteration of all said successive steps, of said current configuration of said reconfigurable intelligent surface, until a predetermined stopping criterion is reached, the optimum configuration of said reconfigurable intelligent surface being associated with the iteration, the cost value of which is maximum.

Thereby, the present invention is based on an isolation of the multi-path involving the reconfigurable intelligent surface (i.e. isolation of the path or paths passing through the reconfigurable intelligent surface) and then on an optimization as such based on a cost function associated with the isolated part of the multi-path only, which makes it possible to maximize the capabilities of the reconfigurable intelligent surface in complicated contexts.

According to other advantageous aspects of the invention, the method for optimizing a reconfigurable intelligent surface comprises one or a plurality of the following features, taken individually or according to all technically possible combinations:
said stopping criterion being reached in at least one of the cases belonging to the group comprising the cases where:
   the value of the cost associated with the current iteration is less than or equal to the value of the cost associated with the preceding iteration;
   the value of the cost associated with the current iteration is greater than a predetermined cost threshold;
   a maximum of iterations performed is reached;
   the signal-to-noise ratio is maximum;
   a predetermined flow-rate value is reached;
   the localization error is minimal;
the current configuration associated with the first iteration is a configuration wherein said reconfigurable intelligent surface is switched off, each element of said plurality of elements being inactivated;
said acquisition is directly the time response of said multi-path channel; and
said isolation is achieved by using a predetermined time windowing of said time response, said time windowing providing the isolated time response of said reconfigurable intelligent surface; and
said cost function corresponds to the average over a predetermined time period of said isolated time response of said reconfigurable intelligent surface; or
said acquisition is with regard to frequency, and
said multi-path channel estimation comprises the transformation, by predetermined inverse Fourier transform, of said frequency acquisition into a time response of said multi-path channel, and
said isolation is achieved by using a predetermined time windowing of said time response, said time windowing providing the isolated time response of said reconfigurable intelligent surface; and
said isolated time response of said reconfigurable intelligent surface is transformed, via a predetermined Fourier transform, into an isolated frequency response of said reconfigurable intelligent surface; and
said cost function corresponds to the average over the frequency band of said isolated frequency response of said reconfigurable intelligent surface:
said time windowing corresponds to a time range centered on the a priori instant associated with the implementation of said component of said reconfigurable intelligent surface during said acquisition, the width of said time range depending on the frequency band of said acquisition;
said acquisition is frequency and spatial, and
said multi-path channel estimation corresponds to a high-resolution estimation of said multi-path channel, and
said isolation is obtained by the difference between the high-resolution estimation obtained from a configuration wherein said reconfigurable intelligent surface is switched off, each element of said plurality of elements being inactivated, and the high-resolution estimation obtained from said current configuration of said reconfigurable intelligent surface, said current configuration being distinct from said switched-off configuration, and
said cost function corresponds to the estimation of the relative power of said component of said reconfigurable intelligent surface in said current configuration;
said high-resolution estimation is implemented using an estimation algorithm belonging to the group comprising at least the following algorithms:
   SAGE or UWB-SAGE;
   RiMAX;
   MUSIC;
   ESPRIT;
said multi-path channel estimation is angular and implemented via a multi-antenna array of said at least one receiver, said multi-antenna array being real by comprising a set of unit antennas distributed in space according to a predetermined layout, or virtual by comprising a single antenna the communication path of which is apt to be modified in said space by displacement of said single antenna and/or of another element of said space.

The invention further relates to a computer program including software instructions which, when executed by a computer, implement a method for optimizing a reconfigurable intelligent surface as defined hereinabove.

It should be noted that in such particular case of implementation by computer program by acquisition is meant only the obtaining of a measurement which is carried out by a measuring device distinct from said computer apt to implement said computer program.

The invention further relates to a communication and/or location system comprising at least:
at least one reconfigurable intelligent surface, said surface comprising a plurality of elements, each controllable in phase and/or amplitude, said reconfigurable intelligent surface being suitable for reflecting or transmitting signals between at least one transmitter and at least one receiver,
said at least one transmitter,
said at least one receiver,
said communication system further comprising an electronic device for optimizing said at least one reconfigurable intelligent surface, said electronic optimization device comprising:
an acquisition module configured to acquire, for a current configuration of said reconfigurable intelligent surface, at least one measurement of the multi-path propagation channel associated with said communication system comprising at least said reconfigurable intelligent surface;
an estimation module configured to estimate the multi-path channel from said acquisition;
an isolation module configured to isolate, within said multi-path channel estimation, the component of said at least one reconfigurable intelligent surface;
a computation module configured to calculate a cost function using said isolated component of said reconfigurable intelligent surface;
said device being apt to reiterate the successive steps of acquisition, estimation, isolation and computation, after modification, at each iteration of all said successive steps, of said current configuration of said reconfigurable intelligent surface, until a predetermined stopping criterion is reached, the optimum configuration of said reconfigurable intelligent surface being associated with the iteration, the cost value of which is maximum

According to another advantageous aspect of the invention, said at least one receiver comprises a multi-antenna array, said multi-antenna array being real by comprising a set of unitary antennas distributed in space according to a predetermined layout, or virtual by comprising a single antenna the communication path of which is apt to be modified in said space by displacement of said single antenna and/or of another element of said space.

### BRIEF DESCRIPTION OF THE DRAWINGS

The invention will be clearer upon reading the following description, given only as an example, but not limited to, and making reference to the drawings wherein:

FIG. 1, described hereinabove, illustrates a favorable case A, and an unfavorable case B, for the optimization according to the prior art of a reconfigurable intelligent surface;

FIG. 2 is a schematic representation of a communication and/or location system according to the invention;

FIG. 3 is a general flowchart of the method for optimizing a reconfigurable intelligent surface according to the present invention;

FIGS. 4 and 5 illustrate two alternative embodiments of the method shown in a general manner in FIG. 3.

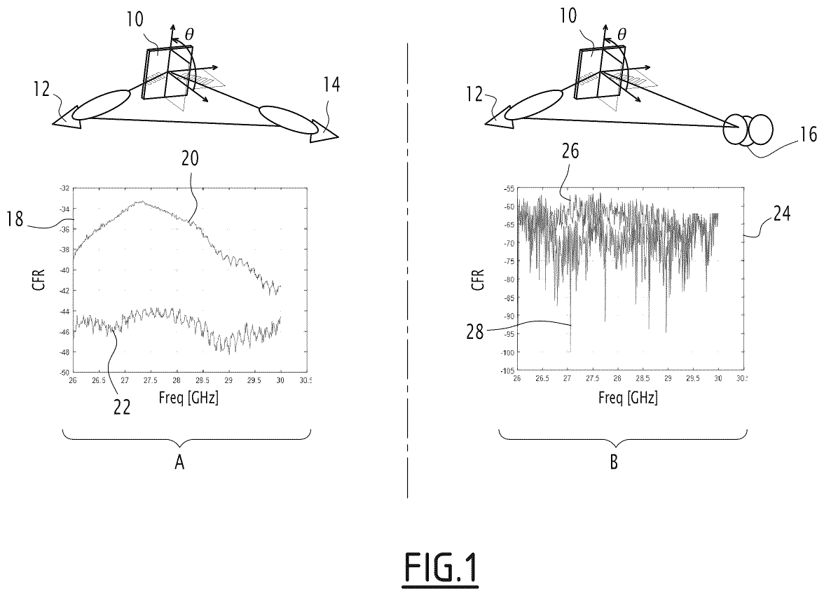

### DETAILED DESCRIPTION

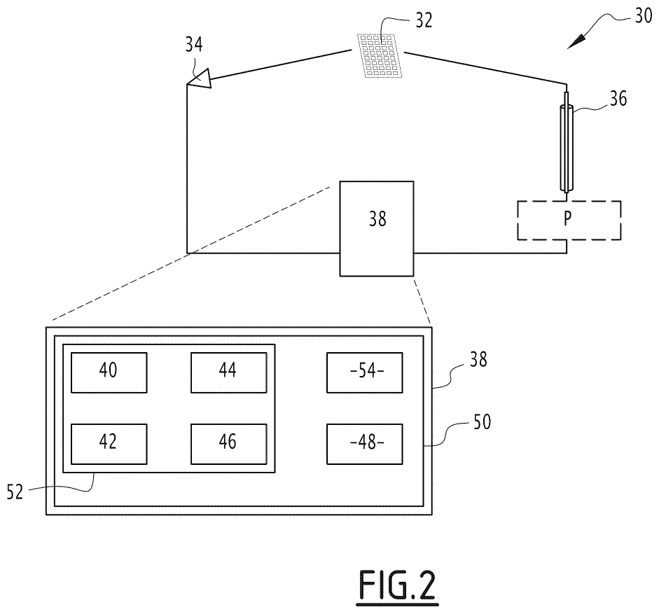

FIG. 2 first schematically illustrates a non-limiting example of system 30 of communication and/or location according to the present invention.

According to the present invention, such a communication and/or location system 30 comprises firstly at least one reconfigurable intelligent surface 32, said surface comprising a plurality of elements, each controllable in phase and/or amplitude, said reconfigurable intelligent surface being suitable for reflecting or transmitting signals between at least one transmitter 34 and at least one receiver 36.

As an example, the transmitter 34 is a base station (BS) and the receiver 36 is a user terminal UE (User Equipment).

In addition, as illustrated in FIG. 2, said communication system 30 further comprises said at least one transmitter 34 and said at least one receiver 36.

Furthermore, specifically according to the present invention, said communication system 30 further comprises an electronic device 38 for optimizing said at least one reconfigurable intelligent surface 32.

Such an electronic optimization device 38 comprises firstly an acquisition module 40 configured to acquire, for a current configuration of said reconfigurable intelligent surface, at least one measurement of the multi-path propagation channel associated with said communication system 30 comprising at least said reconfigurable intelligent surface 32.

Furthermore, such an electronic optimization device 38 comprises an estimation module 42 configured to estimate the multi-path channel from said acquisition.

Moreover, such an electronic optimization device 38 comprises an isolation module 44 configured to isolate, within said multi-path channel estimation, the component of said at least one reconfigurable intelligent surface.

Moreover, such an electronic optimization device 38 further comprises a computation module 46 configured to compute a cost function using said isolated component of said reconfigurable intelligent surface.

By means of said acquisition module 40, estimation module 42, isolation module 44 and computation module 46, said electronic optimization device 38 is apt to reiterate the associated successive acquisition, estimation, isolation and computation steps, after modification, at each iteration of all of said successive steps, of said current configuration of said reconfigurable intelligent surface 32, until reaching a predetermined stopping criterion, the optimal configuration of said reconfigurable intelligent surface 32 being associated with the iteration, the cost value of which is maximum.

As an optional supplement, according to a first variant (not shown), said at least one receiver 36 comprises a multi-antenna array, said multi-antenna array being real by comprising a set of unit antennas distributed in space according to a predetermined layout, e.g. on a line, a circle, within a square surface, etc.

According to a second variant of the optional complement, said at least one receiver 36 comprises a virtual multi-antenna array comprising a single antenna the communication path is apt to be modified in said space by displacement of said single antenna and/or of another element of said space. In other words, such a multi-antenna array is “virtual” because is obtained from a single antenna and by displacement whatever the origin of said displacement, namely, e.g., the displacement of a user carrying said receiver 36, a displacement of said receiver 36 via a positioner P (optional shown in dotted lines) or else the displacement of an object on which the receiver is placed, the object being wider than said receiver 36, such as an automobile, a train, etc., and suitable for forming a network with the single antenna of said receiver 36.

Optionally, shown in dotted lines, said electronic optimization device 38 further comprises a module 48 for measuring, as such, said multi-path channel. For example, such a measurement module 48, embedded within said device 38, is a Vector Network Analyzer (VNA) configured to acquire at least one frequency measurement of said propagation channel and transmit same to said acquisition module 40.

In the example shown in FIG. 2, the optimization electronic device 38 of said reconfigurable intelligent surface 32 comprises an information processing unit 50 consisting e.g. of a memory 52 and of a processor 54 associated with the memory 52.

In the example shown in FIG. 2, the acquisition module, the estimation module, the isolation module and the computation module, are each implemented in the form of a software program, or a software brick, which can be executed by the second processor 54. The memory 52 of the optimization electronic device 38 of said reconfigurable intelligent surface 32 is then apt to store an acquisition software, an estimation software, an isolation software, and a computation software. The first processor is then apt to execute each of the software programs among the acquisition software, the estimation software, the insulation software, and the computation software.

In a variant (not shown) the acquisition module, the estimation module, the isolation module, and the computation module are each implemented in the form of a programmable logic component, such as an FPGA (Field Programmable Gate Array), or further of integrated circuit, such as an ASIC (Application Specific Integrated Circuit).

When the optimization electronic device 38 of said reconfigurable intelligent surface 32 is implemented in the form of one or a plurality of software programs, i.e. in the form of a computer program, same is further apt to be recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium.

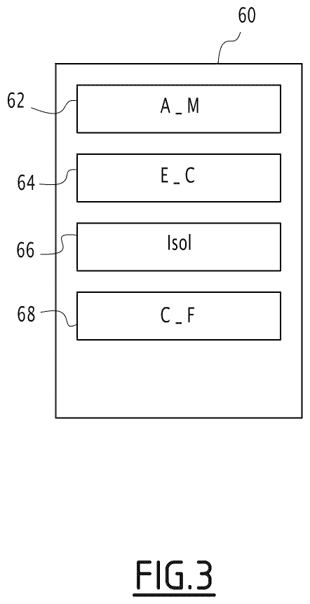

An example of a general embodiment of the operation of the electronic optimization device 38 of said reconfigurable intelligent surface 32 of FIG. 3 is described hereinafter with reference to FIG. 2.

More precisely, the method 60 for optimizing a reconfigurable intelligent surface generally comprises four successive steps 62, 64, 66 and 68.

The first step 62 is a step of acquisition A_M of at least one measurement of the propagation multi-path channel associated with the communication and/or location system, an example of which is illustrated in FIG. 2, said acquisition 62 being implemented for a current configuration of said reconfigurable intelligent surface.

Then, starting from said acquisition 62, the method 60 for optimizing a reconfigurable intelligent surface comprises a second step 64 for estimating said multi-path channel E_C.

Then, the method 60 for optimizing a reconfigurable intelligent surface comprises a step 66 Isol for isolating the component of said reconfigurable intelligent surface within said multi-path channel estimation.

“Component” refers to the part isolated within the multi-path channel estimation of multi-path channel, corresponding (i.e. equal to) the path(s) passing through said reconfigurable intelligent surface. Thereafter, said component of said reconfigurable intelligent surface is also called the “RIS path”.

The method 60 for optimizing a reconfigurable intelligent surface then comprises a step 68 C_F of computing a cost function using said isolated component of said reconfigurable intelligent surface.

The optimization according to said method 60 is iterative, said successive steps 62, 64, 66, 68 being reiterated by the device 38, after modification (not shown in FIG. 2), at each iteration of all said successive steps, of said current configuration of said reconfigurable intelligent surface, until reaching a predetermined stopping criterion, the optimal configuration of said reconfigurable intelligent surface being associated with the iteration the cost value of which is maximum.

In other words, in general, according to the method 60 of the present invention, from an acquisition 62 of the channel, the path of the reconfigurable intelligent surface is isolated 66, e.g. in time and/or spatially, and with or without use of the reconfigurability capacity of the reconfigurable intelligent surface, then at each iteration, a modification of the configuration of the reconfigurable intelligent surface is applied, with or without exploitation of the channel information previously obtained, and a new acquisition 62 of the channel is carried out following the modification, the path of the reconfigurable intelligent surface being extracted 66 (i.e. isolated) again and the change is found my means of said cost function, the optimization continuing by looping-back on the modification (i.e. change of configuration of the reconfigurable intelligent surface) until the level of the isolated path is considered to be satisfactory by means of said cost function.

Modification of the current configuration of the reconfigurable intelligent surface means any change of state of at least one element of said reconfigurable intelligent surface, including the change of state of all the elements at once, in particular when the “off” state of said reconfigurable intelligent surface is changed overall to the “on” state.

Said modification of the current configuration of said reconfigurable intelligent surface is implemented physically at each iteration or, according to an embodiment not shown, via a simulation, the measurement acquisition corresponding, in the case of modification by simulation, to the acquisition of the simulation result of the propagation channel associated with the communication and/or location system comprising said simulated reconfigurable intelligent surface.

As an optional addition, the said criterion for stopping the iterative method 60 is reached in at least one of the cases belonging to the group comprising the cases where:
the value of the cost associated with the current iteration is less than or equal to the value of the cost associated with the preceding iteration;
the value of the cost associated with the current iteration is greater than a predetermined cost threshold;
a maximum of iterations performed is reached;
the signal-to-noise ratio is maximum;
a predetermined flow-rate value is reached;
the localization error is minimal.

For example, said cost threshold is predetermined so as to meet a goal of increasing the component of said reconfigurable intelligent surface (i.e. the path passing through the reconfigurable intelligent surface), a goal of increasing the overall linking budget of said communication and/or location system 30, a goal of increasing the component of said reconfigurable intelligent surface (i.e. the path passing through the reconfigurable intelligent surface) for a predetermined distance and/or angle associated with a geolocation application.

As an optional supplement, current configuration associated with the first iteration is a configuration wherein said reconfigurable intelligent surface is switched off, each element of said plurality of elements being inactivated.

In other words, in the current configuration of said reconfigurable intelligent surface associated with the first iteration, the reconfigurable intelligent surface is in a configuration state “i” which is the state “OFF”.

Alternatively, the current configuration of said reconfigurable intelligent surface associated with the first iteration is a “random” configuration.

At the following iteration, the following configuration obtained after modification is e.g. any arbitrary configuration previously configured from the previous iteration and distinct from the configuration associated with the first iteration (i.e. said configuration corresponding to a predefined state).

During the following iteration, a new acquisition 62 of the channel is performed, which gives rise to estimation 64 of the channel.

The estimation 64 of the channel, which depends on the measurements carried out, is suitable for giving information on the delays and/or the directions of arrival and/or the directions of departure and/or information on the speeds and/or the powers of the multi-path. In other words, said channel estimation 64 makes it possible to obtain a decomposition of the propagation channel.

During the step 66 of isolating each iteration, the path passing through the reconfigurable intelligent surface is isolated either from a priori knowledge of the coordinates thereof or from a “cleaning” of the measurement which as such can be carried out by means of a priori knowledge of the propagation channel or from a deduction following the channel responses acquired during the preceding iterations.

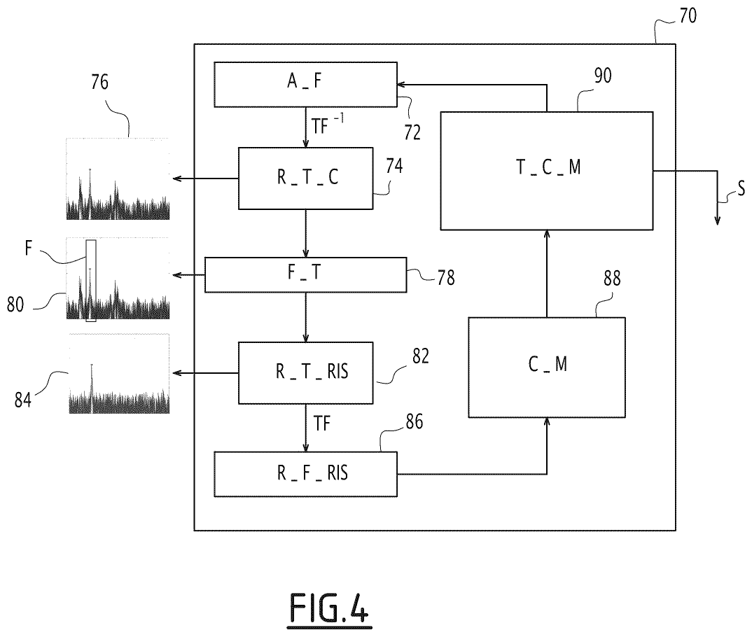

A first variant 70 for implementing said method is illustrated in FIG. 4. According to the first variant 70, said acquisition step 72 is a frequency acquisition A_F.

For example, such an acquisition 72, on the frequency domain only, is suitable for being carried out with a Vector Network Analyzer (VNA) like the optional measurement device 48 of FIG. 2 described hereinabove.

According to the first variant 70, the estimation step 64 for the multi-path channel of FIG. 3 further comprises a step 74 of transforming, by predetermined inverse Fourier transform TF⁻¹, said frequency acquisition A_F into a time response of said multi-path channel R_T_C as illustrated by the view 76.

Said isolation 66 of the general method 60 of FIG. 3 is obtained according to the first variant 70 illustrated by FIG. 4 by using a predetermined time windowing step 78 F_T of said time response.

The view 80 illustrates the application of time windowing and the window F used.

Said time windowing 78 supplies at the output 82 the isolated time response R_T_RIS of said reconfigurable intelligent surface illustrated by the view 84.

As an optional supplement, said time windowing corresponds to a time range centered on the a priori instant associated with the implementation of said component of said reconfigurable intelligent surface during said acquisition, the width of said time range depending on the frequency band of said acquisition.

The time windowing is done around the expected or estimated value of the “RIS” path (i.e. said component of said reconfigurable intelligent surface) and consists simply in choosing a time range centered on the “RIS” path with a width related to the frequency band of the acquisition.

Then, during a step 86, said isolated time response of said reconfigurable intelligent surface is transformed, via a predetermined Fourier transform TF, into an isolated frequency response of said reconfigurable intelligent surface R_F_RIS. The frequency response R_F_RIS of the channel, associated solely with the reconfigurable intelligent surface, is then estimated. Such an estimation is denoted by [symbol] _{RIS} so that:

$${RIS}_{} ( f ) = {H}_{R X} {\hat{α}}_{{l}_{RIS}} {e}^{- j 2 π f {\hat{τ}}_{{l}_{RIS}}} .$$

Step 88 according to the first variant 70 illustrated by FIG. 4 corresponds to step 68 of the general representation of the method according to FIG. 3, namely the step of computation C_M of a cost function using said isolated component of said reconfigurable intelligent surface. More precisely, according to the first variant 70, said cost function corresponds to the average over the frequency band of said isolated frequency response of said reconfigurable intelligent surface. In other words, the computation of the associated cost function amounts to determining the band average of the frequency response of the “RI” channel so that: Cost=| [symbol] _{RIS}(f)|.

In other words, according to the present invention, the cost function advantageously relates only to the part of the channel estimation associated with the path(s) passing through the reconfigurable intelligent surface, and not to the entire channel as known from the prior art.

During step 90, a T_C_M test of the result of said cost function is performed in order to determine whether or not the optimization of the reconfigurable intelligent surface is continued by means of a modification of the latter.

More precisely, the modification of the reconfigurable intelligent surface seeks to increase the parameter αₗ_{_{RIS}} representative of the isolated component of said reconfigurable intelligent surface, and is conditioned by the stopping criterion corresponding to the fact that the Cost(i) associated with the iteration of index i is greater than that of the preceding iteration of index i−1, which is equivalent to: Cost(i)>Cost(i−1), otherwise the optimization method 70 stops along the output arrow S, i.e. if the cost does not increase from one iteration to another.

If the answer is yes, the modification of the reconfigurable intelligent surface is implemented to provide a new configuration of the reconfigurable intelligent surface taken into account at the next iteration of index+1.

Thereby, after such a modification of the reconfigurable intelligent surface, with or without exploitation of the previously obtained channel information, the following iteration of index i+1 of steps 72, 74, 78, 82, 86, 88, and 90 is implemented and so on until the optimization method is stopped along the output arrow S.

Thereby, to summarize, according to the first variant 70 illustrated by FIG. 4, it is possible to efficiently optimize the reconfigurable intelligent surface with only a frequency acquisition 72 of the channel. The isolation of the RIS path is achieved by time windowing and the optimization of the reconfigurable intelligent surface is achieved by the cost function with an average over frequency response of the RIS channel and comparison between iterations.

According to a second variant, said acquisition 62 of FIG. 3 is directly the acquisition of the time response of said multi-path channel, in particular for a so-called impulse communication and/or location system where the impulse response of the channel is directly obtained, which serves to avoid the passage by the inverse Fourier transformation TF⁻¹ and Fourier transformation TF of FIG. 4, namely the aforementioned steps 74 and 86.

According to such second variant, said isolation is obtained by using a predetermined time windowing of said time response, said time windowing providing the isolated time response of said reconfigurable intelligent surface, and said cost function corresponding to the average over a predetermined time period of said isolated time response of said reconfigurable intelligent surface.

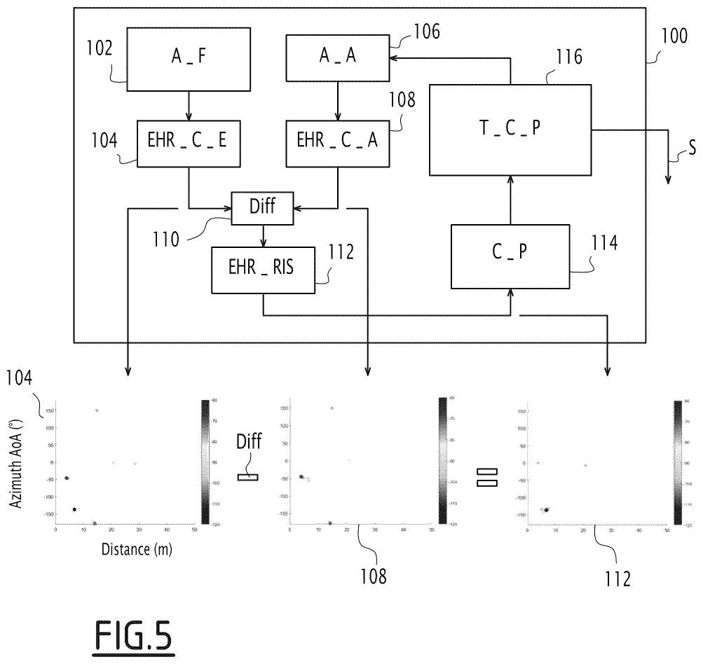

A third variant 100 for implementing said method 60 according to the general representation thereof shown in FIG. 3 is illustrated by FIG. 5.

According to such third variant, said acquisition is in terms of frequency and space. For example, the acquisition of the channel is carried out on the frequency domain, using a Vector Network Analyzer (VNA) like the optional measurement device 48 of FIG. 2 described hereinabove, but also spatially due to the displacement of the receiver (e.g. a user terminal UE (User Equipment)) made e.g. with the positioner P present in FIG. 2 in order to form a so-called virtual multi-antenna array.

Moreover, according to the third variant 100, said multi-path channel estimation corresponds to a high-resolution estimation of said multi-path channel.

As an optional supplement, said high-resolution estimation is implemented using an estimation algorithm belonging to the group comprising at least the following algorithms:
SAGE introduced by B. H Fleury et al. in 1996 in the article entitled “Wideband angle of arrival estimation using the SAGE algorithm”;
RiMAX introduced by T. Reiner et al. in 2004 in the article entitled “RIMAX-A maximum likelihood framework for parameter estimation in multidimensional channel sounding”;
MUSIC introduced by R. Schmidt in 1986 in the article entitled “Multiple emitter location and signal parameter estimation”;
ESPRIT introduced by R. Roy et al. in 1989 in the article entitled “ESPRIT-estimation of signal parameters via rotational invariance techniques”;
etc.

Furthermore, according to the third variant 100, said isolation is obtained by difference between the high-resolution estimation obtained from a configuration wherein said reconfigurable intelligent surface is switched off, each element of said plurality of elements being inactivated, and the high-resolution estimation obtained from said current configuration of said reconfigurable intelligent surface, said current configuration being distinct from said switched-off configuration.

Thereby, as illustrated by FIG. 5, the third variant 100 comprises, on the one hand, the steps 102 et 104 corresponding to the acquisition A_E in terms of frequency and space of a measurement of the channel for configuration wherein said reconfigurable intelligent surface is off, and to the associated high-resolution estimation of channel EHR_C_E, respectively, illustrated at the bottom of FIG. 5 by the corresponding view with the same reference 104, in particular by using the high-resolution algorithm UWB-SAGE as applied according to K. Haneda et al. in 2003 in the article with the title “An application of SAGE algorithm for UWB propagation channel estimation”, and on the other hand the steps 106 and 108 corresponding to the acquisition A_A in terms of frequency and space of a measurement of the channel for a current configuration of said reconfigurable intelligent surface distinct from said off configuration, and to the associated high-resolution estimation of channel EHR_C_A, respectively, illustrated at the bottom of FIG. 5 by the corresponding view with the same reference 108, in particular by using the high-resolution algorithm UWB-SAGE as applied according to K. Haneda et al. in 2003 in the article with the title “An application of SAGE algorithm for UWB propagation channel estimation”.

The steps 102 and 104 on the one hand, and 106 and 108 on the other hand, are suitable for being implemented successively, in particular because it is a switched-off and then switched-on configuration of the reconfigurable intelligent surface without any unitary modification as such of one or part of the elements of the reconfigurable intelligent surface between the off and on state which applies overall to the whole of the reconfigurable intelligent surface.

Step 110 is a step of determining the difference Diff between the two high-resolution channel estimations EHR_C_E and EHR_C_A obtained from two distinct configurations of the reconfigurable intelligent surface including the off configuration.

The high-resolution EHR_RIS estimation of the channel limited to the reconfigurable intelligent surface (i.e. the isolated estimation) is obtained during step 112 as illustrated by the view with the same reference at the bottom of FIG. 5, and corresponds to the result of the difference Diff.

During step 114, the computation C_P of the cost function using said high-resolution EHR_RIS estimation of the channel limited to the reconfigurable intelligent surface is implemented, said cost function corresponding, according to the third variant 100, to the estimation of the relative power of said component of said reconfigurable intelligent surface, namely said high-resolution EHR_RIS estimation of the channel limited to the reconfigurable intelligent surface in said current configuration.

Then, during step 116, a test T_C_P of the result of said cost function is performed in order to determine whether or not the optimization of the reconfigurable intelligent surface is continued by means of a modification thereof, then used during the next iteration by reiterating steps 102, 104 with the modified reconfigurable intelligent surface switched off, then switched-on for steps 106 and 108.

More precisely, the modification of the reconfigurable intelligent surface seeks to increase the parameter αₗ_{_{RIS}} representative of the isolated component of said reconfigurable intelligent surface, and is conditioned by the stopping criterion corresponding to the fact that the Cost(i) associated with the iteration of index i is greater than that of the preceding iteration of index i−1, which is equivalent to: Coûs(i)>Cost(i−1), otherwise the optimization method 100 stops along the output arrow S, i.e. if the cost does not increase from one iteration to another.

In other words, to summarize, the third implementation variant 100 illustrated by FIG. 5 is based on two successive high-resolution channel estimations in the off state and then in the on state (i.e. reconfigurable intelligent surface RIS in ON/OFF states) of the same reconfigurable intelligent surface RIS, then isolation by difference between the two high-resolution estimations of the multi-path linked to the reconfigurable intelligent surface.

More precisely, mathematically, herein the high-resolution algorithm used serves to obtain an estimation of the frequency response of the channel (frequency and position of the receiver because a virtual network in reception is obtained by moving the receiver, in particular via the optional P positioner illustrated by FIG. 2 described hereinabove) such as:

$$( f , m ) = {H}_{RX} ( {\hat{ϕ}}_{{l}_{RIS}} , {\hat{θ}}_{{l}_{RIS}} ) {\hat{α}}_{{l}_{RIS}} {e}^{- j 2 π f {\hat{τ}}_{{l}_{RIS}}} {e}^{- j 2 π \frac{\vec{e} ( {\hat{ϕ}}_{{l}_{RIS} ,} {\hat{θ}}_{{l}_{RIS}} ) \cdot {\vec{r}}_{m}}{λ}} + {\sum }_{l ∈ 〚 1 : L 〛 \backslash \{ {l}_{RIS} \}} {H}_{RX} ( {\hat{ϕ}}_{l} , {\hat{θ}}_{l} ) {\hat{α}}_{l} {e}^{- j 2 π f {\hat{τ}}_{l}} {e}^{- j 2 π \frac{\vec{e} ( {\hat{ϕ}}_{l ,} {\hat{θ}}_{l} ) \cdot {\vec{r}}_{m}}{λ}}$$

Where m is the index of the position of the receiver during the movement thereof with the positioner P, \vec{r}ₘ is the position vector of the receiver, \vec{e}(ϕ, θ) is the unit vector oriented according to (ϕ, θ) with ϕ the angle in azimuth and θ the angle in elevation, \hat{ } indicates a parameter estimated by the high-resolution algorithm and λ is the wavelength.

The isolation of the RIS multi-path consists in keeping only the term where the reconfigurable intelligent surface contributes:

$${RIS}_{} ( f , m ) = {H}_{RX} ( {\hat{ϕ}}_{{l}_{RIS} ,} {\hat{θ}}_{{l}_{RIS}} ) {\hat{α}}_{{l}_{RIS}} {e}^{- j 2 π f {\hat{τ}}_{{l}_{RIS}}} {e}^{- j 2 π \frac{\vec{e} ( {\hat{ϕ}}_{{l}_{RIS} ,} {\hat{θ}}_{{l}_{RIS}} ) \cdot {\vec{r}}_{m}}{λ}}$$

In order to identify the contribution term of the reconfigurable intelligent surface RIS, the case where once the reconfigurable intelligent surface is switched-off (i.e. off state) is thus considered, one has indeed αₗ_{_{RIS}}≈0, and it is proposed to implement, before or after, an estimation with the reconfigurable intelligent surface switched-on (i.e. ON state) in order to obtain, from the difference between the estimation associated with the two overall off/on states of the reconfigurable intelligent surface, the part solely dependent on the reconfigurable intelligent surface:

$${RIS}_{} ( f , m ) = {RIS ON}_{} ( f , m ) - {RIS OFF}_{} ( f , m )$$

Finally, the optimization of the path passing through the reconfigurable intelligent surface is carried out once the expected change of the appropriate path is observed, herein one thus seeks to maximize | [symbol] _{RIS}(f, m)|. The optimization is performed simply by comparing one iteration with another or with gradient descent methods for a local optimization. For global optimizations, it is necessary to envisage more systematic known approaches such as e.g. a search on a parameter grid, etc.

In addition or as an alternative, according to a fourth variant (not shown), said multi-path channel estimation is angular and implemented via a multi-antenna array of said at least one receiver, said multi-antenna array being real by comprising a set of unit antennas distributed in space according to a predetermined layout, or virtual by comprising a single antenna the communication path of which is apt to be modified in said space by displacement of said single antenna and/or of another element of said space.

A person skilled in the art would understand that the invention is not limited to the embodiments described, nor to the particular examples of the description, the above-mentioned embodiments and variants being suitable for being combined with one another so as to generate new embodiments of the invention.

The present invention thereby makes it possible to solve the problem of optimizing a reconfigurable intelligent surface in cases not explored hitherto in the prior art, based on an isolation of the path(s) coming from the reconfigurable intelligent surface and then an optimization solely on the basis of the result of the isolation.

An optimization of one reconfigurable intelligent surface or a plurality of reconfigurable intelligent surfaces in complex scenarios, is thereby obtained. The proposed optimization solution for a reconfigurable intelligent surface is also applicable to optimizations of such reconfigurable intelligent surfaces in transmission and/or reflection and makes possible or improves a possible or improved location and mapping.

1. A method for optimizing a reconfigurable intelligent surface, said surface comprising a plurality of elements, each controllable in phase and/or amplitude, said reconfigurable intelligent surface being suitable for reflecting or transmitting signals between at least one transmitter and at least one receiver, said method being implemented by an electronic device and comprising the following successive steps:
acquisition of at least one measurement of the propagation multi-path channel associated with the communication and/or location system, said system comprising at least said reconfigurable intelligent surface, said at least one transmitter and said at least one receiver, said acquisition being implemented for a current configuration of said reconfigurable intelligent surface;
on the basis of said acquisition, estimation of said multi-path channel;
within said multi-path channel estimation, isolation of the component of said reconfigurable intelligent surface;
computation of a cost function using only said isolated component of said reconfigurable intelligent surface;
said successive steps being reiterated after modification, at each iteration of all said successive steps, of said current configuration of said intelligent reconfigurable surface, until a predetermined stopping criterion is reached, the optimum configuration of said intelligent reconfigurable surface being associated with the iteration the cost value of which is maximum.

2. The method according to claim 1, wherein said stopping criterion is reached in at least one of the cases belonging to the group comprising the cases where:
the value of the cost associated with the current iteration is less than or equal to the value of the cost associated with the preceding iteration;
the value of the cost associated with the current iteration is greater than a predetermined cost threshold;
a maximum of iterations performed is reached;
the signal-to-noise ratio is maximum;
a predetermined flow-rate value is reached;
the localization error is minimal.

3. The method according to claim 1, wherein the current configuration associated with the first iteration is a configuration wherein said reconfigurable intelligent surface is switched off, each element of said plurality of elements being inactivated.

4. The method according to claim 1, wherein:
said acquisition is directly the time response of said multi-path channel; and
said isolation is achieved by using a predetermined time windowing of said time response, said time windowing providing the isolated time response of said reconfigurable intelligent surface; and
said cost function corresponds to the average over a predetermined time period of said isolated time response of said reconfigurable intelligent surface; or
said acquisition is with regard to frequency, and
said multi-path channel estimation comprises the transformation, by predetermined inverse Fourier transform, of said frequency acquisition into a time response of said multi-path channel, and
said isolation is achieved by using a predetermined time windowing of said time response, said time windowing providing the isolated time response of said reconfigurable intelligent surface; and
said isolated time response of said reconfigurable intelligent surface is transformed, via a predetermined Fourier transform, into an isolated frequency response of said reconfigurable intelligent surface; and
said cost function corresponds to the average over the frequency band of said isolated frequency response of said reconfigurable intelligent surface.

5. The method according to claim 4, wherein said time windowing corresponds to a time range centered on the a priori instant associated with the implementation of said component of said reconfigurable intelligent surface during said acquisition, the width of said time range depending on the frequency band of said acquisition.

6. The method according to claim 1, wherein:
said acquisition is frequency and spatial, and
said multi-path channel estimation corresponds to a high-resolution estimation of said multi-path channel, and
said isolation is obtained by difference between the high-resolution estimation obtained from a configuration wherein said reconfigurable intelligent surface is switched off, each element of said plurality of elements being inactivated, and the high-resolution estimation obtained from said current configuration of said reconfigurable intelligent surface, said current configuration being distinct from said switched-off configuration, and
said cost function corresponds to the estimation of the relative power of said component of said reconfigurable intelligent surface in said current configuration.

7. The method according to claim 6, wherein said high-resolution estimation is implemented using an estimation algorithm belonging to the group comprising at least the following algorithms:
SAGE or UWB-SAGE;
RiMAX;
MUSIC;
ESPRIT.

8. The method according to claim 1, wherein said multi-path channel estimation is angular and implemented via a multi-antenna array of said at least one receiver, said multi-antenna array being real by comprising a set of unit antennas distributed in space in a predetermined layout, or virtual by comprising a single antenna the communication path of which is apt to be modified in said space by displacement of said single antenna and/or of another element of said space.

9. A computer program including software instructions which, when executed by a computer, implement an optimization method of a reconfigurable intelligent surface according to claim 1.

10. A communication and/or location system comprising at least:
one reconfigurable intelligent surface, said surface comprising a plurality of elements, each controllable in phase and/or amplitude, said reconfigurable intelligent surface being suitable for reflecting or transmitting signals between at least one transmitter (34) and at least one receiver,
said at least one transmitter,
said at least one receiver,
wherein said communication system being further comprises an electronic device for optimizing said at least one reconfigurable intelligent surface, said electronic optimization device comprising:
an acquisition module configured to acquire, for a current configuration of said reconfigurable intelligent surface, at least one measurement of the multi-path propagation channel associated with said communication system comprising at least said reconfigurable intelligent surface;
an estimation module configured to estimate the multi-path channel from said acquisition;
an isolation module configured to isolate, within said multi-path channel estimation, the component of said at least one reconfigurable intelligent surface;
a computation module configured to calculate a cost function using only said isolated component of said reconfigurable intelligent surface;
said device being apt to reiterate the successive steps of acquisition, estimation, isolation and computation, after modification, at each iteration of all said successive steps, of said current configuration of said reconfigurable intelligent surface, until a predetermined stopping criterion is reached, the optimum configuration of said reconfigurable intelligent surface being associated with the iteration, the cost value of which is maximum.

11. The communication and/or location system according to claim 10 wherein said at least one receiver comprises a multi-antenna array, said multi-antenna array being real by comprising a set of unitary antennas distributed in space according to a predetermined layout, or virtual by comprising a single antenna the communication path of which is apt to be modified in said space by displacement of said single antenna and/or of another element of said space.
